(19) United States
(12) Patent Application Publication
(10) Pub. No.: US 2022/0151256 A1
(43) Pub. Date: May 19, 2022

(54) SUSTAINABLE FOOD SOURCE FROM PERENNIAL GRASS

(71) Applicant: Joel Steven Goldberg, Hillsborough, NC (US)

(72) Inventor: Joel Steven Goldberg, Hillsborough, NC (US)

(21) Appl. No.: 17/589,004

(22) Filed: Jan. 31, 2022

(51) Int. Cl. A23F 3/34; A23F 3/22; A23L 2/72; A23L 2/80; A23L 2/39; A23L 5/20; A23L 5/00

(52) U.S. Cl. CPC A23F 3/34; A23F 3/22; A23L 2/72; A23L 5/51; A23L 2/39; A23L 5/276; A23L 2/80

(57) ABSTRACT

Perennial grasses can be a source of sustainable and renewable food supplies. Unlike efforts in selective genetics to produce grains with perennial phenotypes, this invention processes perennial grasses that can be efficiently and economically extracted to produce an easily stored food that does not require refrigeration. Grasses are cut, juice is extracted, centrifuged, treated with non-activated coconut charcoal, filtered , microscopically examined to assure minimal cellulose content, and dehydrated to produce a stable solid that can be rehydrated or incorporated into flours. Yields from fresh grass extraction exceeds those from rehydration of hay. Non-activated coconut charcoal is a renewable and inexpensive resource. Perennial pasture grasses grown with clover or other legumes require minimal yearly fertilization. This process can be sustainable in societies without electricity.

### CROSS-REFERENCES TO RELATED APPLICATIONS

None

### FEDERALLY FUNDED RESEARCH

Not applicable

### BACKGROUND OF THE INVENTION

World food supplies are expected to become very scarce by the year 2050, especially affecting those in Sub-Saharan Africa and South East Asia. The Haber-Bosch process for fixation of ammonia and the Green Revolution allowed continual population growth, but the carrying capacity of the earth's population is predicated to be compromised by 2050 with food insecurity. A strategy must be undertaken to provide for food, and this may be compromised by global warming. This invention is an extension of previous work demonstrating that perennial pasture grass has well-established growing characteristics, nutritional content, and can be easily harvested. Perennial pasture grass can be processed as a sustainable source of food, and the addition of nitrogen fixing plants, such as clover or other legumes, increases sustainability.

Perennial food supply offers substantial advantages over the cultivation of annual food crops. These advantages include:

1. Single planting:

a. Less germination risks

b. Significant energy savings

c. Reduced labor costs

d. Reduced depreciation of machinery

2. Protection against soil erosion

These advantages are so significant that a number of agencies around the globe are heavily invested in perennial food sources. The focus of these investments is genetic modification of existing food sources such as wheat, rice, and oats, and selection of a phenotype that will be perennial.[1-3] Clearly this is an important effort, but it may take years to breed such varieties, and the varieties may be subject to unanticipated environmental factors such as disease, drought, and climate change.

Perennial ryegrass has been show to contain all of the essential amino acids needed for human sustenance, and the cellulose content can be extracted with centrifugation and filtration making the extract palatable for human consumption.[4, 5] Perennial ryegrass and other perennial grasses do not need to be planted yearly, but can be established in the pasture for long periods. The energy conservation of a perennial food crop is enormous compared to the energy required for yearly plantings of wheat, oats, and rice. In order to maintain adequate nitrogen balance, incorporation of a nitrogen fixation species such as clover can produce food crops without yearly planting and without yearly nitrogen fertilization.[6, 7]

### DRAWINGS

None

### DETAILED DESCRIPTION OF THE INVENTION

Previously it was shown that perennial ryegrass could be processed by softening of the fibers with citrate that presumably chelates calcium and disrupts pectin stabilizing bonds which improves extraction of the juice from the grass.[4] While this decalcification may be required for some grasses depending upon the time of harvest and fiber content, it may not be universally essential for processing some dried grasses which are rehydrated prior to juicing. Furthermore, it was shown that centrifugation and filtration produced an extract of the grass with less microscopic cellulose than wheat grass extract, which is commonly consumed by humans.[5] The centrifugation needs to precede the filtration process to be efficient. The centrifugation speed was less than 3000 rpm, a speed that can be obtained with a manual centrifugation device. The extract is purified with non-activated coconut charcoal, a renewable resource, which makes the extract more palatable and then filtered. The adsorptive properties of non-activated coconut charcoal have not been extensively investigated, and its use is not obvious. Unlike activated charcoal, non-activated coconut charcoal is sustainable and renewable. Charcoal adsorption of the extract improves the taste. Prior work to improve the taste of extracted grass and leaf green crops has utilized organic solvents, cation exchange, or electrodialysis[8-10]

The entire process from harvesting of the grass to isolation of palatable powder is inexpensive, and it can be performed where electricity is not available. The addition of nitrogen fixing plants such as clover or other legumes has been shown to produce perennial pastures that are sustainable requiring minimal fertilization. This invention extends the processing of fresh perennial grass or dehydrated (hay) to a stable, soluble, palatable, and nutritional powder with a minimal number of purification steps.

### Experimental Section

Perennial ryegrass was harvested, washed, juiced with an extraction device, centrifuged, treated with non-activated coconut charcoal, filtered, and microscopically examined for cellulose as previously described. After water evaporation a stable dry product formed that was comprised of reflective crystals. This method was also performed on spinach and wheatgrass and resulted in a dry stable solid with reflective crystals. Attempts to isolate a purified protein from the extract by salting out with sodium chloride or by adjusting pH were not successful. Although harvested grass could be dried and rehydrated prior to extraction, best yields were obtained with freshly cut grass. Once the extraction process is begun, it should proceed to completion in a timely fashion, especially the last dehydration process, to avoid a gummy final product. The dehydration process should immediately commence after filtration.

Various liquids were treated with non-activated coconut charcoal after which they were vacuum filtered with a control. These experiments were easily conducted and repeated. The results were unequivocal that non-activated coconut charcoal adsorbs methylene blue and iodine. Also, treatment of the grass extract with activated charcoal could produce a nearly a tasteless extract.

### Benefits to Society

As the population on our planet continues to increase, the carrying capacity for food will eventually outstrip the supply. Thomas Robert Malthus predicted this hundreds of year ago, but technology has been able to expand food supplies, largely from the contributions of Haber and Borlaug and others in the field of agronomy. This invention demonstrates that food for human consumption can be extracted from perennial grasses, even in underdeveloped societies without electricity. The process that is described in this invention is renewable and sustainable.

### REFERENCES

1. DeHaan, L., et al., Roadmap for Accelerated Domestication of an Emerging Perennial Grain Crop. Trends Plant Sci, 2020. 25(6): p. 525-537.
2. Meister, M. Protein from green biomass without the taste of cowshed www.food.dtu.dk 2020.
3. Southey, F. Extracting protein from grass: ‘It should be cheap to buy, offer good funtionality in food, and it must be tasty’ www.foodnavigator.com. 2019.

### 4. Goldberg, J. S., DECALCIFICATION OF PASTURE GRASS FOR FOOD AND FUEL US 2016/0270425 A1 USPTO, 2016.

### 5. Goldberg, J. S., PROCESSING OF PERENNIAL RYE GRASS (LOLIUM PERENNE) FOR HUMAN CONSUMPTION US 2019/0281864 A1 USPTO, 2019.

6. Caradus, J. R., Woodfield, D. R., Stewart, A. V., Overview and vision for white clover. Agronomy Society of New Zealand Special Publication No. 11/Grassland Research and Practice Series No.6.
7. Hogh-Jensen, H., Schjoerring, J. K., Interactions between white clover and ryegrass under contrasting nitrogen availability: N₂ Fixation, N fertilizer recovery, N transfer and water use efficiency. Plant and Soil, 1997. 197(2): p. 187-199.
8. Bickoff, E. M., PREPARATION OF SOLUBLE EDIBLE PROTEIN FROM LEAFY GREEN CROPS U.S. Pat. No. 4,006,078 USPTO, 1977.
9. Graham, J., W. R., Kohler, G. O., Frye, E. E., WATER SOLUBLE PRODUCTS RECOVERED FROM FORAGE CROPS U.S. Pat. No. 2,483,634A USPTO, 1949.
10. Hagiwara, Y., PLANT EXTRACT U.S. Pat. No. 6,022,573A USPTO, 2000.

1. A method to process a perennial grass to be digested by a human comprised of:
a. cutting the grass
b. extracting a juice from said grass
c. centrifugation of the juice
d. addition of a charcoal to said juice
e. separation of said juice and the charcoal to a palatable filtrate
f. microscopic examination of the filtrate
g. dehydration of said filtrate to produce a stable solid food.

2. A method to process a perennial grass to be digested by a human comprised of:
a. cutting the grass
b. extracting a juice from said grass
c. centrifugation of the juice
d. addition of a non-activated coconut charcoal to said juice
e. separation of said juice and the charcoal to a palatable filtrate
f. microscopic examination of the filtrate
g. dehydration of said filtrate to produce a stable solid food.
